(19) United States
(12) Patent Application Publication
(10) Pub. No.: US 2018/0300326 A1
(43) Pub. Date: Oct. 18, 2018

(54) Three-Dimensional Massive Model Visualization Database System

(71) Applicant: The Boeing Company, Chicago, IL (US)

(72) Inventors: James J. Troy, Issaquah, WA (US); William D. McGarry, Federal Way, WA (US); Nikoli E. Prazak, Renton, WA (US); Michael Patrick Sciarra, Seattle, WA (US); Vladimir Karakusevic, Kirkland, WA (US); John Carney Gass, Sammamish, WA (US); William E. Ward, Boise, IA (US)

(21) Appl. No.: 15/489,045

(22) Filed: Apr. 17, 2017

(51) Int. Cl. G06F 17/30; G06T 1/60; G06F 3/0482

(52) U.S. Cl. CPC G06F 17/3028; G06T 1/60; G06T 17/00; G06F 17/30294; G06F 3/0482

(57) ABSTRACT

A method and system for managing three-dimensional massive model visualization data sets. The method comprises compiling a vehicle list of vehicles for which the three-dimensional massive model visualization data sets are to be built. The method automatically builds the three-dimensional massive model visualization data sets for vehicles in the vehicle list using a computer system. The method stores the three-dimensional massive model visualization data sets in a group of repositories. The method distributes the three-dimensional massive model visualization data sets for displaying massive model visualizations for the vehicles using the three-dimensional massive model visualization data sets on client devices. The method may selectively update a three-dimensional massive model visualization data set in the three-dimensional massive model visualization data sets when the three-dimensional massive model visualization data set is out-of-date.

### BACKGROUND INFORMATION

### 1. Field

The present disclosure relates generally to manufacturing, and in particular, to a method and apparatus for manufacturing vehicles using a three-dimensional massive model visualization system.

### 2. Background

In manufacturing aircraft, large three-dimensional data sets, referred to here as three-dimensional massive model visualization data sets, are used to display three-dimensional models of an aircraft to users. A three-dimensional massive model visualization data set is a collection of three-dimensional models in vehicles, such as aircraft. The three-dimensional massive model visualization data sets may have a myriad of models for thousands to millions of parts for the vehicle.

The display of these three-dimensional massive model visualization data sets are often referred to as massive model visualizations (MMV). For example, a user may visualize different configurations of an aircraft in which these configurations are displayed using a three-dimensional massive model visualization data set of the aircraft of interest. Different options may be selected to display how different configurations would look.

Further, the three-dimensional massive model visualization data sets are also used in the manufacturing process for aircraft. With three-dimensional massive model visualization data sets, visualizations of the progress of the aircraft may be made to more effectively communicate information to engineers, managers, or other human operators involved in the manufacturing process.

For example, the assemblies in an aircraft may be displayed in a manner to show the state of assemblies for the aircraft at different times, as well as the current state of the aircraft. With this display, the human operator may quickly obtain an understanding of the assembly progress for a particular aircraft on a line.

Further, the three-dimensional massive model visualization data sets may be displayed to show the state of work orders for different assemblies. For example, the aircraft may be displayed with color coding or other graphic indicators to indicate the state of work orders for different assemblies. For example, color coding displayed with the assemblies to indicate the state of work orders, such as on time, delayed, completed, in progress, or other states of manufacture.

Three-dimensional massive model visualization of complex objects, such as aircraft, usually involve the display of large amounts of three-dimensional model geometry that may originate from many different storage locations. Locating and processing the three-dimensional model items needed for visualizing an aircraft may be a challenging and time-consuming process.

Three-dimensional massive model visualization data sets may be used to visualize complex objects such as aircraft. Three-dimensional massive model visualization data sets are pre-built, self-contained datasets that have been optimized to allow for high-performance interactive visualization of complex three-dimensional data.

Currently, the user locates the three-dimensional models needed to build a three-dimensional massive model visualization data set for a configuration that the user desires to see for an aircraft. The user then builds the three-dimensional massive model visualization data set on the user computer. This process requires the user to know how to configure the build process. Additionally, having available computing resources to process all the models and other data needed for a three-dimensional massive model visualization data set is also needed on a user computer.

Therefore, it would be desirable to have a method and apparatus that take into account at least some of the issues discussed above, as well as other possible issues. For example, it would be desirable to have a method and apparatus that overcome a technical problem with finding, building, and managing three-dimensional objects using three-dimensional massive model visualization data sets.

### SUMMARY

An embodiment of the present disclosure provides a method for managing three-dimensional massive model visualization data sets. The method comprises compiling a list of objects for which the three-dimensional massive model visualization data sets are to be built. The method automatically builds the three-dimensional massive model visualization data sets for objects in the list using a computer system. The method stores the three-dimensional massive model visualization data sets in a group of repositories. The method distributes the three-dimensional massive model visualization data sets for displaying massive model visualizations for the objects using the three-dimensional massive model visualization data sets on client devices. The method receives user input of a request for selectively updating a three-dimensional massive model visualization data set in the three-dimensional massive model visualization data sets when the three-dimensional massive model visualization data set is out-of-date.

Another embodiment of the present disclosure provides a method for displaying three-dimensional massive model visualization data sets on a client device. The method comprises displaying a vehicle list of vehicles displayable that are on the client device. The method downloads a three-dimensional massive model visualization data set in the three-dimensional massive model visualization data sets corresponding to a vehicle selected from the vehicle list from a group of repositories in a computer system. The method displays a three-dimensional massive model visualization of the vehicle using the three-dimensional massive model visualization data set downloaded to the client device.

Yet another embodiment of the present disclosure provides a three-dimensional massive model visualization data sets system. The system comprises a computer system and a data set manager. The data set manager runs on the computer and is configured to compile a vehicle list of vehicles for which three-dimensional massive model visualization data sets are to be built. The data set manager automatically builds the three-dimensional massive model visualization data sets for vehicles in the vehicle list using the computer system. The data set manager stores the three-dimensional massive model visualization data sets in a group of repositories. The data set manager distributes the three-dimensional massive model visualization data sets for displaying three-dimensional massive model visualizations for the vehicles using the three-dimensional massive model visualization data sets on client devices. The data set manager receives user input of a request for selectively updating a three-dimensional massive model visualization data set in the three-dimensional massive model visualization data sets when the three-dimensional massive model visualization data set is out-of-date.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a three-dimensional massive model visualization environment in accordance with an illustrative embodiment;

FIG. 2 is an illustration of a distribution interface in accordance with an illustrative embodiment;

FIG. 3 is an illustration of a three-dimensional massive model visualization interface in accordance with an illustrative embodiment;

FIG. 4 is an illustration of a flowchart of a process for managing three-dimensional massive model visualization data sets in accordance with an illustrative embodiment;

FIG. 5 is an illustration of a flowchart of a process for automatic creation of three-dimensional massive model visualization data sets in accordance with an illustrative embodiment;

FIG. 6 is an illustration of a flowchart of a process for retrieving a three-dimensional massive model visualization data set in accordance with an illustrative embodiment;

FIG. 7 is an illustration of a block diagram of a data processing system in accordance with an illustrative embodiment;

FIG. 8 is an illustration of an aircraft manufacturing and service method in accordance with an illustrative embodiment;

FIG. 9 is an illustration of an aircraft in which an illustrative embodiment may be implemented; and

FIG. 10 is an illustration of a block diagram of a product management system in accordance with an illustrative embodiment.

### DETAILED DESCRIPTION

The illustrative embodiments recognize and take into account one or more different considerations. For example, the illustrative embodiments recognize and take into account that building a three-dimensional massive model visualization data set for complex object such as an aircraft places many requirements on a user. For example, the illustrative embodiments recognize and take account that the user will need to locate and obtain models for the different components of the aircraft, as well as other information, to build a three-dimensional massive model visualization data set. In locating models, the illustrative embodiments recognize and take into account that the user will need knowledge of query languages and which database selections to make in obtaining the correct models to build a three-dimensional massive model visualization data set.

Further, the illustrative embodiments also recognize and take into account the time needed to build a three-dimensional massive model visualization data set for use in visualizing an aircraft may be longer than desired. For example, building a three-dimensional massive model visualization data set may take one hour, two hours, or some other amount of time. This amount of time maybe problematic depending on when the visualization of the aircraft is needed. For example, the time is unpractical for users who often cannot devote their computing time to that purpose.

Also, the illustrative embodiments recognize and take account that the user will need to manage the three-dimensional massive model visualization data sets. The illustrative embodiments recognize and take into account that this management maybe problematic. For example, the illustrative embodiments recognize and take into account that the user will need to name and store the three-dimensional massive model visualization data sets in a location for use at another time. Misplaced data, poorly managed three-dimensional massive model visualization data sets, wasted hard drive space used to store old three-dimensional massive model visualization data sets, as well as other issues may result. The dataset downloaded onto shared devices and using up all the storage space with multiple users. The client software may be configured for multi-user operation to overcome this problem.

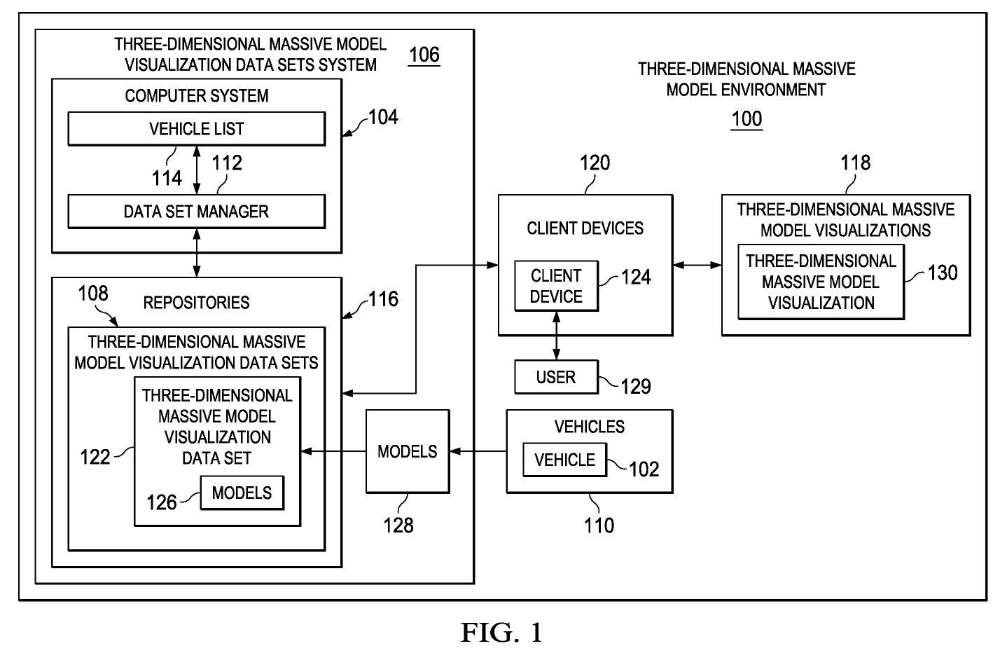

Thus, the illustrative embodiments recognize and take into account that an improved process for creating and managing three-dimensional massive model visualization data sets for users is needed. With reference now to the figures, and in particular with reference to FIG. 1, an illustration of a block diagram of a three-dimensional massive model environment is depicted in accordance with an illustrative embodiment. As depicted, three-dimensional massive model environment 100 is an environment in which the displaying of vehicle 102 may be made using computer system 104 that generates three-dimensional massive model visualization data sets 108 that may be distributed to client devices 120 to display massive model visualizations on those client devices.

In this illustrative example, vehicle 102 may take various forms. For example, vehicle 102 may be selected from a group comprising a mobile platform, an aircraft, an airplane, a rotorcraft, a surface ship, a tank, a personnel carrier, a train, a spacecraft, a submarine, a bus, an automobile, and other suitable types of vehicles.

As depicted, computer system 104 is a physical hardware system and includes one or more data processing systems. When more than one data processing system is present, those data processing systems are in communication with each other using a communications medium. The communications medium may be a network. The data processing systems may be selected from at least one of a computer, a server computer, a tablet, or some other suitable type of data processing system.

As used herein, the phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A, one of item B, and ten of item C; four of item B and seven of item C; or other suitable combinations.

In this illustrative example, three-dimensional massive model visualization data sets system 106 is present in computer system 104. Three-dimensional massive model visualization data sets system 106 is configured to create and manage three-dimensional massive model visualization data sets 108 for a group of vehicles 110. As used herein, a “group of” when used with reference to items means one or more items. For example, a group of vehicles 110 is one or more of vehicles 110.

Three-dimensional massive model visualization data sets system 106 in computer system 104 includes data set manager 112. As depicted, data set manager 112 in computer system 104 is configured to compile vehicle list 114 of vehicles 110 for which three-dimensional massive model visualization data sets 108 are to be built. Further, data set manager 112 is also configured to automatically build three-dimensional massive model visualization data sets 108 for vehicles 110 in vehicle list 114 using computer system 104 and store three-dimensional massive model visualization data sets 108 in a group of repositories 116.

In this illustrative example, models 128 are models for vehicles 110. In other words, these are models that may be used to create three-dimensional massive model visualization data sets 108 for vehicles 110 identified in vehicle list 114 of vehicles 110. Further, data set manager 112 is configured to distribute three-dimensional massive model visualization data sets 108 to repositories 116. The distribution is for client devices 120 to obtain three-dimensional massive model visualization data sets 108 from repositories 116 to display three-dimensional massive model visualizations 118 for vehicles 110 using three-dimensional massive model visualization data sets 108 on client devices 120.

In the illustrative examples, client devices 120 are hardware devices that include processor units for processing information, such as three-dimensional massive model visualization data sets 108. Client devices 120 may take a number of different forms. For example, client devices 120 maybe selected from at least one of a tablet computer, a workstation, a server computer, a laptop computer, or some other suitable type of data processing system.

As depicted, three-dimensional massive model visualization data set 122 in three-dimensional massive model visualization data sets 108 may represent a configuration for a vehicle in vehicles 110. In another illustrative example, three-dimensional massive model visualization data set 122 may represent an instance of a vehicle. The representation of vehicles 110 may be for already produced vehicles, vehicles in production, vehicles that are being designed, or vehicles in some other state.

Data set manager 112 also is configured to selectively update three-dimensional massive model visualization data set 122 in three-dimensional massive model visualization data sets 108 in repositories 116 when three-dimensional massive model visualization data set 122 is out-of-date. For example, data set manager 112 may update three-dimensional massive model visualization data set 122 located on a group of repositories 116.

In other illustrative examples, client devices 124 may update three-dimensional massive model visualization data set 122 located on client device 124. Data set manager 112 sending at least one of a message, a command, program code, or other information to client device 124 that causes client device 124 indicate that an update is needed. The indication may be that when an updated three-dimensional massive model visualization data set is available for specific instances (e.g. a specific airplane line number). As a result, client device 124 may ask user 129 (through a dialog box of some type) if user 129 wants to update that specific instance. The update on client device 124 may be performed with a manual approval from user 129. Client device 124 indicates if an update is available, but user 129 provides the input as to whether an update will occur.

When updating three-dimensional massive model visualization data set 122 on client device 124, clients devices 124 may download all of a newest three-dimensional massive model visualization data set from a repository when user input is received to update three-dimensional massive model visualization data set 122.

In another example, at least one of data set manager 112 or client device 124 may rebuild all of three-dimensional massive model visualization data set 122. Data set manager 112 may rebuild three-dimensional massive model visualization data set 122 located in the repositories 116.

Client device 124 may rebuild all of three-dimensional massive model visualization data set 122 on client device 124. In another example, client device 124 may rebuild a first portion of the three-dimensional massive model visualization data set 122 on client device 124 that is out-of-date while a second portion of three-dimensional massive model visualization data set 122 is unchanged. These portions may be different in size and the portion may be discontinuous.

In the illustrative of example, the three-dimensional massive model visualization data set may be considered to be out-of-date when the current three-dimensional massive model visualization data set on client device 124 has a different timestamp from the version in repositories 116. The three-dimensional massive model visualization data set may also be considered to be out-of-date when a model shape has changed, a location of a model has changed, a configuration of vehicles has changed, or some other change that makes three-dimensional massive model visualization data set 122 no longer current.

In still another illustrative example, client device 124 may update three-dimensional massive model visualization data set 122 located on client device 124 by at least one of masking a first group of models 126 or adding a second group of models 128 for three-dimensional massive model visualization data set 122. In masking the first group of models, the item identifier may be removed from the display list.

In the illustrative example, data set manager 112 in three-dimensional massive model visualization data sets system 106 may provide the data set creation dates with three-dimensional massive model visualization data sets 108 stored in repositories 116. Client devices 120 may access these creation dates in repositories 116. This data allows client devices 120 to determine what has changed.

With three-dimensional massive model visualization data sets 108 being automatically built and updated, user 129 may more easily visualize vehicles 110 using three-dimensional massive model visualization data sets 108 corresponding to vehicles 110. For example, three-dimensional massive model visualizations 118 of vehicle 110 may be displayed on client device 124 using three-dimensional massive model visualization data sets 108 obtained from repositories 116. In one illustrative example, client device 124 may display three-dimensional massive model visualization 130 for a given vehicle from vehicle list 114 of vehicles 110 that are displayable using three-dimensional massive model visualization data sets 108 stored in the group of repositories 116 in computer system 104, to thereby display a given configuration of vehicle 102 from vehicle list 114 of vehicles 110.

Data set manager 112 may be implemented in software, hardware, firmware or a combination thereof. When software is used, the operations performed by data set manager 112 may be implemented in program code configured to run on hardware, such as a processor unit. When firmware is used, the operations performed by data set manager 112 may be implemented in program code and data and stored in persistent memory to run on a processor unit. When hardware is employed, the hardware may include circuits that operate to perform the operations in data set manager 112 in computer system 104 within three-dimensional massive model visualization data sets system 106. Client device 120 includes client-side software that may be used to visualize three-dimensional massive model visualization data sets 108 stored in repositories 116 as three-dimensional massive model visualizations 118.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

Computer system 104 is a physical hardware system and includes one or more data processing systems. When more than one data processing system is present, those data processing systems are in communication with each other using a communications medium. The communications medium may be a network. The data processing systems may be selected from at least one of a computer, a server computer, a tablet, or some other suitable data processing system.

In one illustrative example, one or more technical solutions are present that overcome a technical problem with a technical problem with finding, building, and managing three-dimensional objects using three-dimensional massive model visualization data sets. As a result, one or more technical solutions may provide a technical effect to automating and increasing the ease at which three-dimensional massive model visualization data sets are used in client devices.

As a result, computer system 104, when running program code for processes in data set manager 112, operates as a special purpose computer system in which data set manager 112 in computer system 104 enables creating and performing other operations in managing three-dimensional massive model visualization data sets 108. As used herein, the terms “computer system,” “comparator,” “manager,” “component,” or “module” may include a hardware and/or software system that operates to perform one or more functions. For example, the comparator, manager, module, component, or system may include a computer processor, controller, or other logic-based device that performs operations based on instructions stored on a tangible and non-transitory computer readable storage medium, such as a computer memory. Alternatively, the comparator, manager, module, component, or system may include a hard-wired device that performs operations based on hard-wired logic of the device.

The flowcharts, modules, or components shown in the attached figures may represent the hardware that operates based on software instructions and hardware logic, the software that directs hardware to perform the operations, or a combination thereof. In particular, data set manager 112 running one or more processes on computer system 104 transforms computer system 104 into a special purpose computer system as compared to currently available general computer systems that do not have data set manager 112.

The illustration of three-dimensional massive model environment 100 in FIG. 1 is not meant to imply physical or architectural limitations to the manner in which an illustrative embodiment may be implemented. Other components, in addition to or in place of the ones illustrated, may be used. Some components may be unnecessary. Also, the blocks are presented to illustrate some functional components. One or more of these blocks may be combined, divided, or combined and divided into different blocks when implemented in an illustrative embodiment.

For example, different users on client device 124 share one or more common three-dimensional massive model visualization data sets that may be stored on client device 124. In another illustrative example, the same three-dimensional massive model visualization data set may be obtained from the group of repositories 116, such as a cloud storage system, such that a user may access the same three-dimensional massive model visualization data set at different ones of client devices 120.

Another illustrative example may be applied to objects in addition to or in place of vehicles 110. For example, objects may be selected from at least one of a mobile platform, a stationary platform, a land-based structure, an aquatic-based structure, a space-based structure, an aircraft, a surface ship, a tank, a personnel carrier, a train, a spacecraft, a space station, a satellite, a submarine, an automobile, a power plant, a bridge, a dam, a house, a manufacturing facility, a building, or some other suitable type of object for which a three-dimensional massive model visualization is desired.

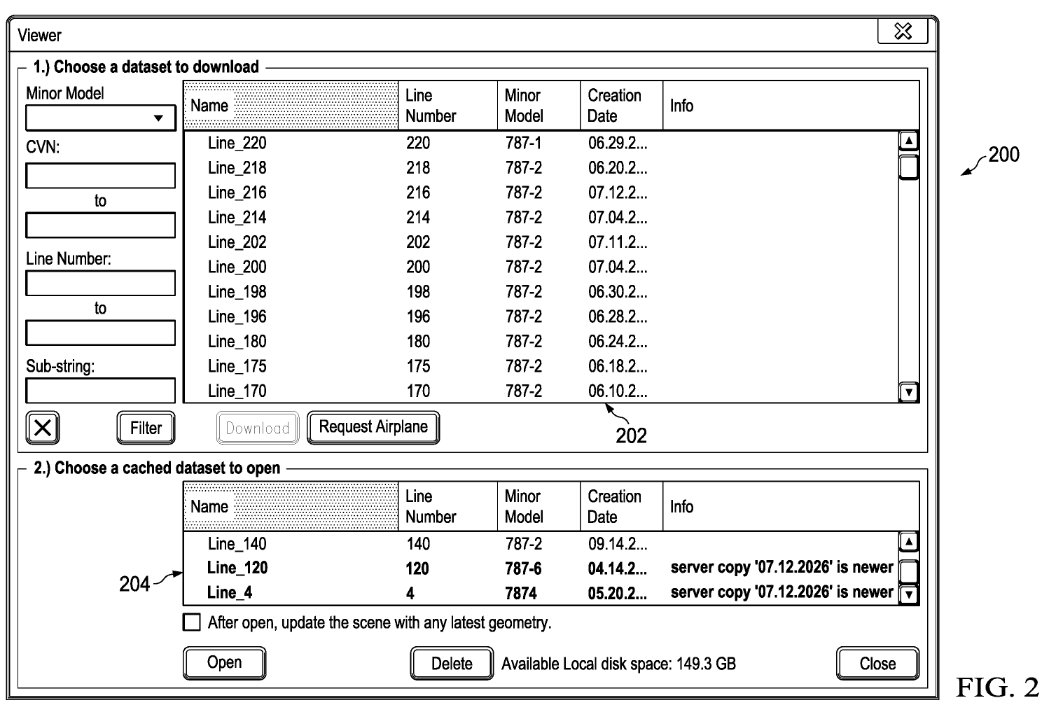

With reference next to FIG. 2, an illustration of a distribution interface is depicted in accordance with an illustrative embodiment. In this illustrative example, distribution interface 200 is an example of a graphical user interface that may be displayed on client devices 120 of FIG. 1.

As depicted, distribution interface 200 displays a list of three-dimensional massive model visualization data sets that may be accessed by a user. In this example, section 202 shows a list of massive model visualization data sets that may be downloaded to a client device. A selection of a three-dimensional massive model visualization data set from section 202 results in the selected three-dimensional massive model visualization data set being downloaded to the client device.

In this illustrative example, section 204 illustrates three-dimensional massive model visualization data sets that have been cached or stored locally on the client device.

A user may select a three-dimensional massive model visualization data set from section 204 for display. The selection of a three-dimensional massive model visualization data set from section 204 results in a three-dimensional massive data set being displayed by a visualization application.

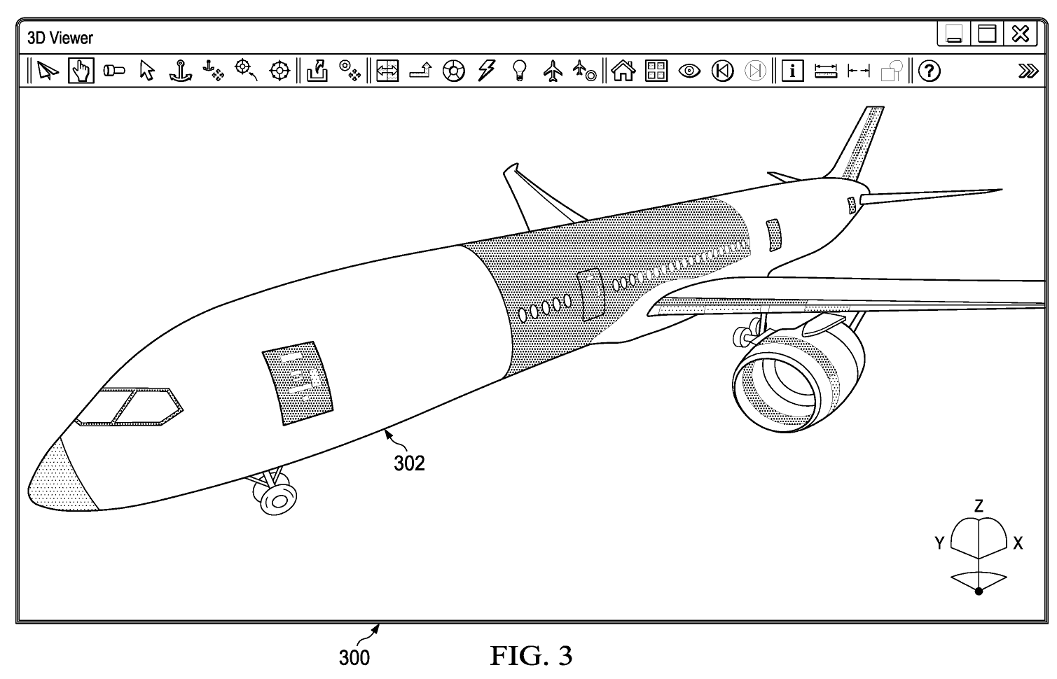

With reference now to FIG. 3, an illustration of a three-dimensional massive model visualization interface is depicted in accordance with an illustrative embodiment. In this illustrative example, three-dimensional massive model visualization interface 300 is an example of a graphical user interface that may be displayed on client device 124 of FIG. 1.

In this illustrative example, airplane 302 is displayed in three-dimensional massive model visualization interface 300. The display of airplane 302 is made in response to a selection of a three-dimensional massive model visualization data set from section 204 of distribution interface 200 in FIG. 2.

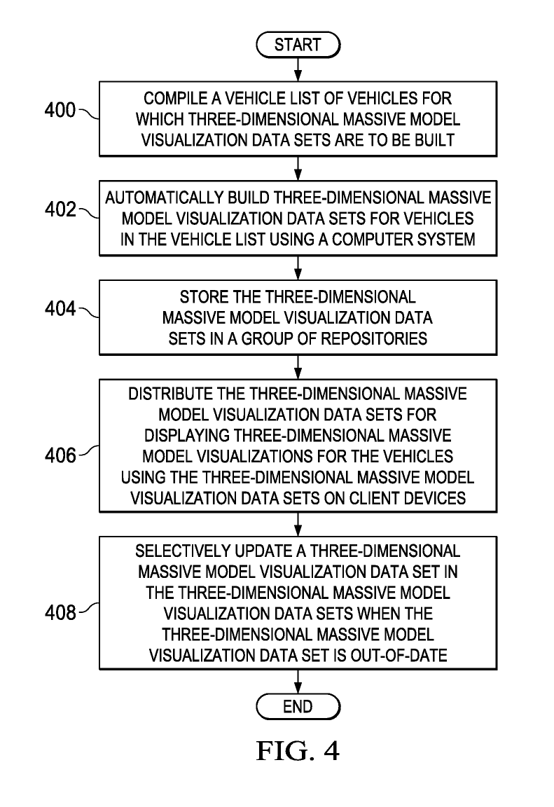

Turning next to FIG. 4, a flowchart of a process for managing three-dimensional massive model visualization data sets is depicted in accordance with an illustrative embodiment. The process illustrated in FIG. 4 may be implemented in three-dimensional massive model environment 100 in FIG. 1. The different operations may be implemented as program code that is run by one or more processor units in computer system 104 in FIG. 1. The processor units may be in the same data processing system or a different data processing systems, depending on the implementation. For example, the operations in FIG. 4 may be implemented in data set manager 112 in FIG. 1.

The process begins by compiling a vehicle list of vehicles for which three-dimensional massive model visualization data sets are to be built (operation 400). In operation 400, the vehicle list is a build list that may identify vehicles, such as aircraft by model, line number, part numbers, location of visualization data, distribution information, rebuild frequency, and other information that may be used to create three-dimensional massive model visualization data sets for the vehicles.

The process automatically builds three-dimensional massive model visualization data sets for vehicles in the vehicle list using a computer system (operation 402). In operation 402, the automatic building may be performed by a data set manager directly, or by the data set manager initiating other processes that build the three-dimensional massive model visualization data sets. Further, the building of the three-dimensional massive model visualization data sets may be initiated by trigger events. The trigger events may be, for example, a date of delivery for an aircraft, a date when manufacturing of aircraft, or other dates or events that may be used to trigger the automatic building of the three-dimensional massive model visualization data sets.

The process stores the three-dimensional massive model visualization data sets in a group of repositories (operation 404). The three-dimensional massive model visualization data sets may be stored in repositories in various locations. The locations of repositories may depend on various factors, such as geographic location of client devices that will access the three-dimensional massive model visualization data sets, network configurations, bandwidth availability, and other suitable factors.

The process distributes the three-dimensional massive model visualization data sets for displaying three-dimensional massive model visualizations for the vehicles using the three-dimensional massive model visualization data sets on client devices (operation 406). The distribution may include retrieval of the massive model visualization data sets by client devices. In other illustrative examples, the distribution includes sending location information to users. The location information may include, for example, lists or links to the three-dimensional massive model visualization data sets.

The process selectively updates a three-dimensional massive model visualization data set in the three-dimensional massive model visualization data sets when the three-dimensional massive model visualization data set is out-of-date (operation 408). The process terminates thereafter. In other illustrative examples, this process may be repeated any number of times.

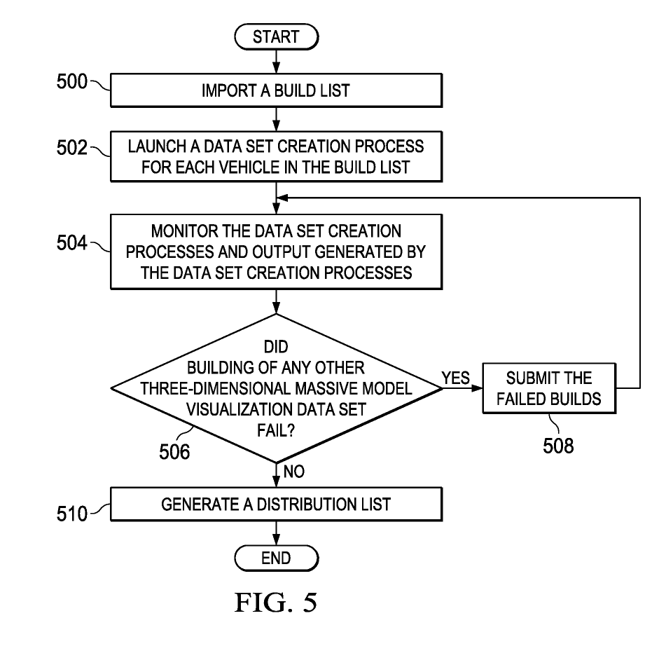

With reference next to FIG. 5, a flowchart of a process for automatic creation of three-dimensional massive model visualization data sets is depicted in accordance with an illustrative embodiment. The process illustrated in FIG. 5 is an example of one implementation for operation 402 in FIG. 4.

The process illustrated in FIG. 5 may be implemented in three-dimensional massive model environment 100 in FIG. 1. The different operations may be implemented as program code that is run by one or more processor units in computer system 104 in FIG. 1. The processor units may be in the same data processing system or different data processing systems, depending on the implementation.

The process begins by importing a build list (operation 500). The process launches a data set creation process for each vehicle in the build list (operation 502).

The process monitors the data set creation processes and output generated by the data set creation processes (operation 504). The process determines whether building of any of the three-dimensional massive model visualization data sets failed (operation 506). If the building of any of the three-dimensional massive model visualization data sets failed, the process submits those failed builds (operation 508). The process then returns to operation 504. Otherwise, the process generates a distribution list (operation 510). The process terminates thereafter.

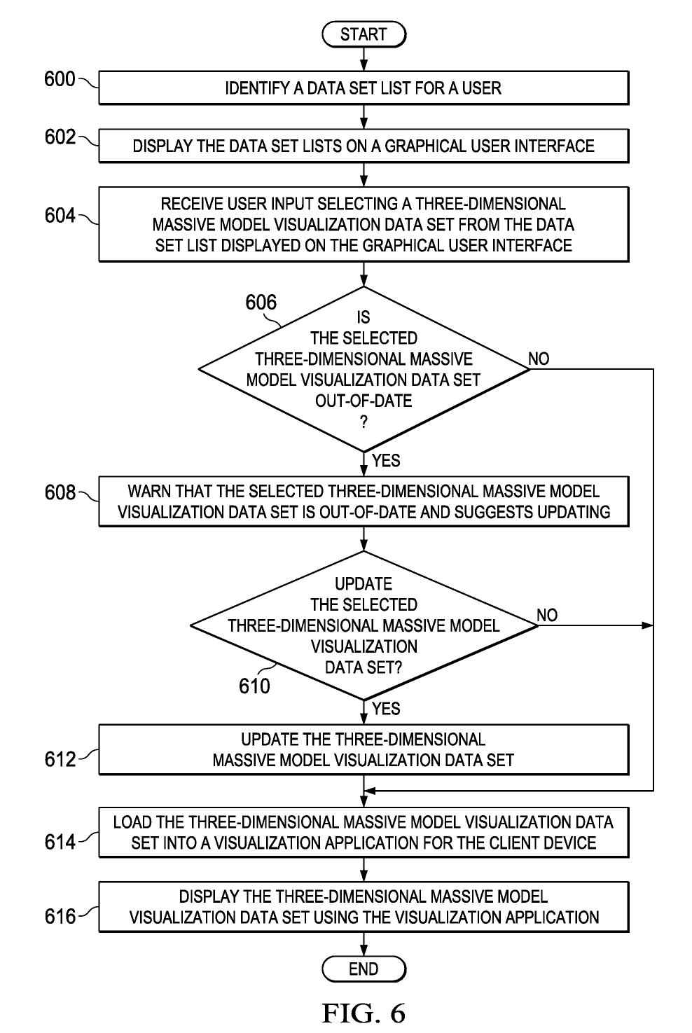

With reference now to FIG. 6, a flowchart of a process for retrieving a three-dimensional massive model visualization data set is depicted in accordance with an illustrative embodiment. The process illustrated in FIG. 6 may be implemented in three-dimensional massive model environment 100 in FIG. 1. The different operations may be implemented as program code that is run by one or more processor units in computer system 104 in FIG. 1. The processor units may be in the same data processing system or different data processing systems, depending on the implementation. For example, these operations may be implemented in client devices 120 to generate three-dimensional massive model visualization 130 of FIG. 1.

The process begins by identifying a data set list for a user (operation 600). The data set list is a list of three-dimensional massive model visualization data sets that have been assigned or distributed to the user for visualization for other uses. The process displays the data set list on a graphical user interface (operation 602).

The process receives user input selecting a three-dimensional massive model visualization data set from the data set list displayed on the graphical user interface (operation 604). The process determines whether the selected three-dimensional massive model visualization data set is out-of-date (operation 606). In operation 606, the determination as to whether the three-dimensional massive model visualization data set is out-of-date may be made in a number different ways. For example, the determination may be made by comparing timestamps, date modified information, or other suitable forms of information that may be used to indicate whether a three-dimensional massive model visualization data set is out-of-date.

If the three-dimensional massive model visualization data set is out-of-date, the process warns that the selected three-dimensional massive model visualization data set is out-of-date and suggests updating (operation 608). In operation 608, the user may choose to update the three-dimensional massive model visualization data set or use the current one that is out-of-date. A determination is made as to whether to update the selected three-dimensional massive model visualization data set (operation 610). This determination may be made from user input indicating whether an update should occur.

If the three-dimensional massive model visualization data set is to be updated, the process updates the three-dimensional massive model visualization data set (operation 612). The update in operation 612 may be performed in a number different ways. For example, the update may be made by patching the existing three-dimensional massive model visualization dataset with new information or by downloading a newer version of the three-dimensional massive model visualization data set from the server.

For example, an updated version of the three-dimensional massive model visualization data set may be downloaded from a repository. In another example, the client device may perform the update locally without downloading another three-dimensional massive model visualization data set. In other illustrative examples, the client device may mask models that are no longer used and download models that may have been added to the three-dimensional massive model visualization data set to obtain updated information for displaying a three-dimensional massive model visualization.

The process then loads the three-dimensional massive model visualization data set into a visualization application for the client device (operation 614). The process displays the three-dimensional massive model visualization using the visualization application (operation 616). The process terminates thereafter.

With reference again to operation 610, if the three-dimensional massive model visualization data set is not to be updated, the process proceeds to operation 614 as described above. With reference back to operation 606, if the selected three-dimensional massive model visualization data set is not out-of-date, the process proceeds to operation 614.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added, in addition to the illustrated blocks, in a flowchart or block diagram.

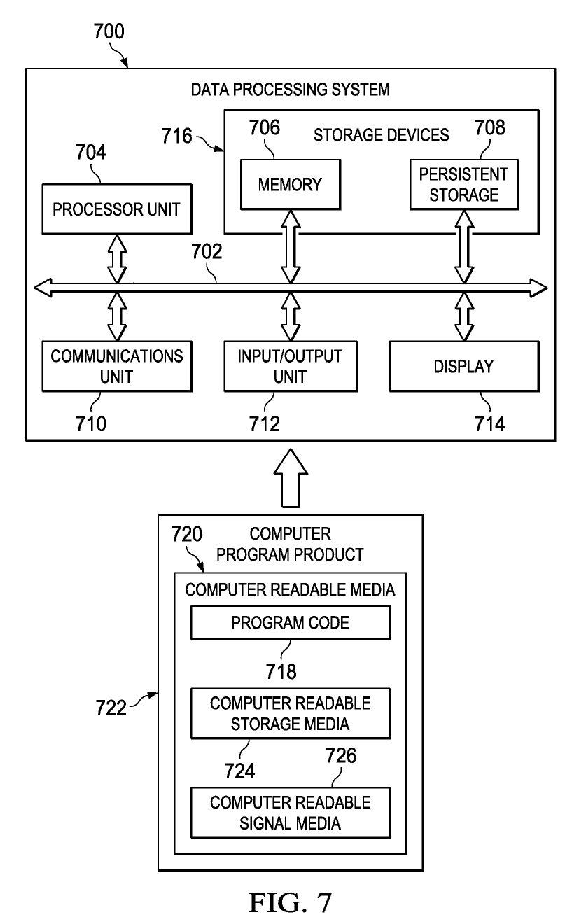

Turning now to FIG. 7, an illustration of a block diagram of a data processing system is depicted in accordance with an illustrative embodiment. Data processing system 700 may be used to implement one or more data processing systems in computer system 104 of FIG. 1. Data processing system 700 also may be used to implement client devices 120 in FIG. 1. In this illustrative example, data processing system 700 includes communications framework 702, which provides communications between processor unit 704, memory 706, persistent storage 708, communications unit 710, input/output unit 712, and display 714. In this example, communication frameworks 702 may take the form of a bus system.

Processor unit 704 serves to execute instructions for software that may be loaded into memory 706. Processor unit 704 may be a number of processors, a multi-processor core, or some other type of processor, depending on the particular implementation.

Memory 706 and persistent storage 708 are examples of storage devices 716. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 716 may also be referred to as computer-readable storage devices in these illustrative examples. Memory 706, in these examples, may be, for example, a random-access memory or any other suitable volatile or non-volatile storage device. Persistent storage 708 may take various forms, depending on the particular implementation.

For example, persistent storage 708 may contain one or more components or devices. For example, persistent storage 708 may be a hard drive, a solid state hard drive, a flash memory, a rewritable optical disk, a rewritable magnetic tape, or some combination of the above. The media used by persistent storage 708 also may be removable. For example, a removable hard drive may be used for persistent storage 708.

Communications unit 710, in these illustrative examples, provides for communications with other data processing systems or devices. In these illustrative examples, communications unit 710 is a network interface card.

Input/output unit 712 allows for input and output of data with other devices that may be connected to data processing system 700. For example, input/output unit 712 may provide a connection for user input through at least one of a keyboard, a mouse, or some other suitable type of input device. Further, input/output unit 712 may send output to a printer. Display 714 provides a mechanism to display information to a user.

Instructions for at least one of the operating system, applications, or programs may be located in storage devices 716, which are in communication with processor unit 704 through communications framework 702. The processes of the different embodiments may be performed by processor unit 704 using computer-implemented instructions, which may be located in a memory, such as memory 706.

These instructions are referred to as program code, computer-usable program code, or computer-readable program code that may be read and executed by a processor in processor unit 704. The program code in the different embodiments may be embodied on different physical or computer-readable storage media, such as memory 706 or persistent storage 708.

Program code 718 is located in a functional form on computer-readable media 720 that is selectively removable and may be loaded onto or transferred to data processing system 700 for execution by processor unit 704. Program code 718 and computer-readable media 720 form computer program product 722 in these illustrative examples. In one example, computer-readable media 720 may be computer-readable storage media 724 or computer-readable signal media 726.

In these illustrative examples, computer-readable storage media 724 is a physical or tangible storage device used to store program code 718 rather than a medium that propagates or transmits program code 718. Alternatively, program code 718 may be transferred to data processing system 700 using computer-readable signal media 726. Computer-readable signal media 726 may be, for example, a propagated data signal containing program code 718. For example, computer-readable signal media 726 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 700 are not meant to provide architectural limitations to the manner in which different embodiments may be implemented. The different illustrative embodiments may be implemented in a data processing system including components, in addition to or in place of those illustrated, for data processing system 700. Other components shown in FIG. 7 can be varied from the illustrative examples shown. The different embodiments may be implemented using any hardware device or system capable of running program code 718.

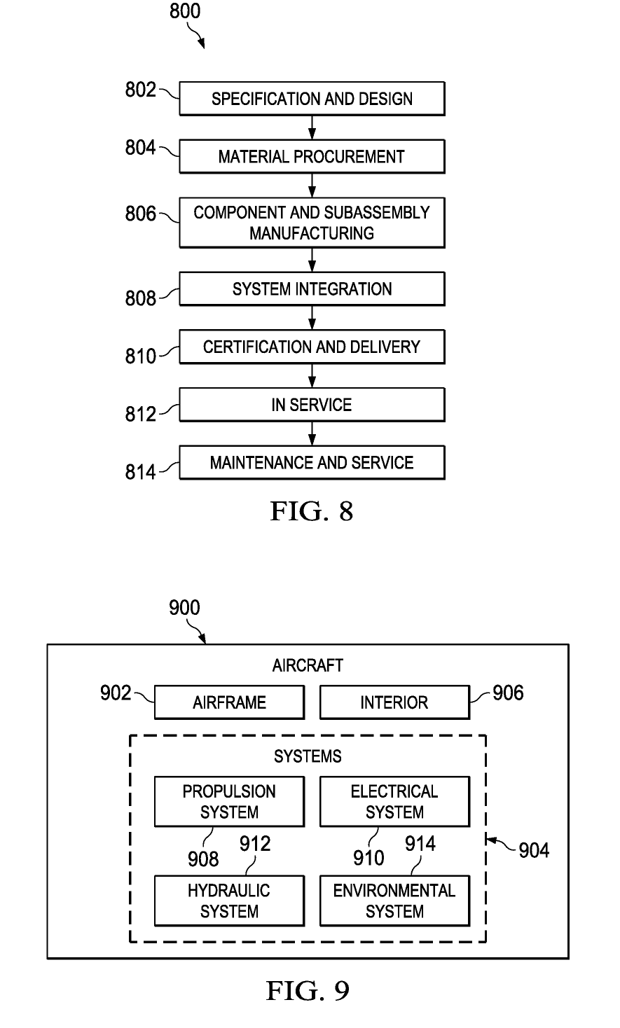

Illustrative embodiments of the disclosure may be described in the context of aircraft manufacturing and service method 800 as shown in FIG. 8 and aircraft 900 as shown in FIG. 9. Turning first to FIG. 8, an illustration of an aircraft manufacturing and service method is depicted in accordance with an illustrative embodiment. During pre-production, aircraft manufacturing and service method 800 may include specification and design 802 of aircraft 900 in FIG. 9 and material procurement 804.

During production, component and subassembly manufacturing 806 and system integration 808 of aircraft 900 in FIG. 9 takes place. Thereafter, aircraft 900 in FIG. 9 may go through certification and delivery 810 in order to be placed in service 812. While in service 812 by a customer, aircraft 900 in FIG. 9 is scheduled for routine maintenance and service 814, which may include modification, reconfiguration, refurbishment, or other maintenance and service.

Each of the processes of aircraft manufacturing and service method 800 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 9, an illustration of an aircraft is depicted in which an illustrative embodiment may be implemented. In this example, aircraft 900 is produced by aircraft manufacturing and service method 800 in FIG. 8 and may include airframe 902 with plurality of systems 904 and interior 906. Examples of systems 904 include one or more of propulsion system 908, electrical system 910, hydraulic system 912, and environmental system 914. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 800 in FIG. 8. For example, three-dimensional massive model visualization data sets system 106 in FIG. 1 may be used to display different configurations for aircraft 900 during specification and design 802 of aircraft 900, component and subassembly manufacturing 806, and system integration 808. As another example, three-dimensional massive model visualization data sets system 106 also may be used to create and display aircraft 900 during routine maintenance and service 814. For example, the display of the configurations may be used to plan or implement work orders for modification, reconfiguration, refurbishment, or other maintenance and service for aircraft 900.

In one illustrative example, components or subassemblies produced in component and subassembly manufacturing 806 in FIG. 8 may be fabricated or manufactured in a manner similar to components or subassemblies produced while aircraft 900 is in service 812 in FIG. 8. As yet another example, one or more apparatus embodiments, method embodiments, or a combination thereof may be utilized during production stages, such as component and subassembly manufacturing 806 and system integration 808 in FIG. 8. One or more apparatus embodiments, method embodiments, or a combination thereof may be utilized while aircraft 900 is in service 812, during maintenance and service 814 in FIG. 8, or both. The use of a number of the different illustrative embodiments may substantially expedite the assembly of aircraft 900, reduce the cost of aircraft 900, or both expedite the assembly of aircraft 900 and reduce the cost of aircraft 900.

For example, with automated creation of three-dimensional massive model visualization data sets 108, the amount of time and effort needed to create these data sets for viewing on client devices may be reduced. Further, data set manager 112 also provides an ability to update three-dimensional massive model visualization data sets 108 used by client devices 120. As result, less effort and knowledge is needed by users of client devices 120 to view three-dimensional massive model visualizations 118 for vehicles 110.

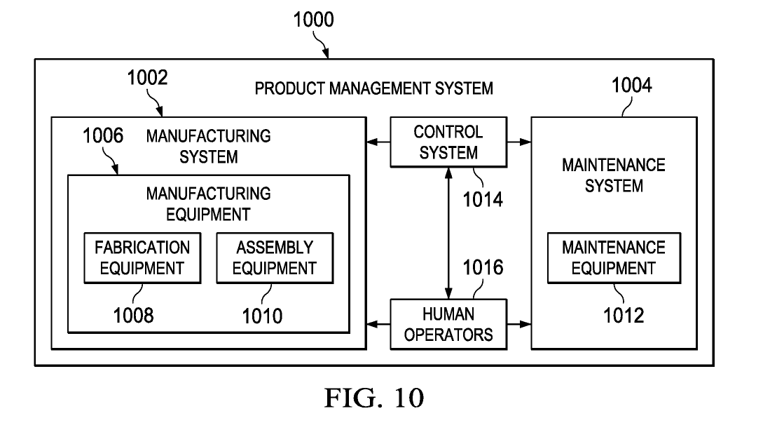

Turning now to FIG. 10, an illustration of a block diagram of a product management system is depicted in accordance with an illustrative embodiment. Product management system 1000 is a physical hardware system. In this illustrative example, product management system 1000 may include at least one of manufacturing system 1002 or maintenance system 1004.

Manufacturing system 1002 is configured to manufacture products, such as aircraft 900 in FIG. 9. As depicted, manufacturing system 1002 includes manufacturing equipment 1006. Manufacturing equipment 1006 includes at least one of fabrication equipment 1008 or assembly equipment 1010.

Fabrication equipment 1008 is equipment that may be used to fabricate components for parts used to form aircraft 900. For example, fabrication equipment 1008 may include machines and tools. These machines and tools may be at least one of a drill, a hydraulic press, a furnace, a mold, a composite tape laying machine, a vacuum system, a lathe, or other suitable types of equipment. Fabrication equipment 1008 may be used to fabricate at least one of metal parts, composite parts, semiconductors, circuits, fasteners, ribs, skin panels, spars, antennas, or other suitable types of parts.

Assembly equipment 1010 is equipment used to assemble parts to form aircraft 900. In particular, assembly equipment 1010 may be used to assemble components and parts to form aircraft 900. Assembly equipment 1010 also may include machines and tools. These machines and tools may be at least one of a robotic arm, a crawler, a faster installation system, a rail-based drilling system, or a robot. Assembly equipment 1010 may be used to assemble parts such as seats, horizontal stabilizers, wings, engines, engine housings, landing gear systems, and other parts for aircraft 900.

In this illustrative example, maintenance system 1004 includes maintenance equipment 1012. Maintenance equipment 1012 may include any equipment needed to perform maintenance on aircraft 900. Maintenance equipment 1012 may include tools for performing different operations on parts on aircraft 900. These operations may include at least one of disassembling parts, refurbishing parts, inspecting parts, reworking parts, manufacturing replacement parts, or other operations for performing maintenance on aircraft 900. These operations may be for routine maintenance, inspections, upgrades, refurbishment, or other types of maintenance operations.

In the illustrative example, maintenance equipment 1012 may include ultrasonic inspection devices, x-ray imaging systems, vision systems, drills, crawlers, and other suitable devices. In some cases, maintenance equipment 1012 may include fabrication equipment 1008, assembly equipment 1010, or both to produce and assemble parts that may be needed for maintenance.

Product management system 1000 also includes control system 1014. Control system 1014 is a hardware system and may also include software or other types of components. Control system 1014 is configured to control the operation of at least one of manufacturing system 1002 or maintenance system 1004. In particular, control system 1014 may control the operation of at least one of fabrication equipment 1008, assembly equipment 1010, or maintenance equipment 1012.

The hardware in control system 1014 may be using hardware that may include computers, circuits, networks, and other types of equipment. The control may take the form of direct control of manufacturing equipment 1006. For example, robots, computer-controlled machines, and other equipment may be controlled by control system 1014. In other illustrative examples, control system 1014 may manage operations performed by human operators 1016 in manufacturing or performing maintenance on aircraft 900. For example, control system 1014 may assign tasks, provide instructions, display models, or perform other operations to manage operations performed by human operators 1016.

In these illustrative examples, three-dimensional massive model visualization data sets system 106 and data set manager 112 may be implemented in control system 1014 to manage at least one of the manufacturing or maintenance of aircraft 900 in FIG. 9. With data set manager 112, three-dimensional massive model visualization data sets 108 may be created and managed for use by client devices 120 in viewing three-dimensional massive model visualizations 118 of products, such as vehicles 110 of FIG. 1. These visualizations may be made for at least one of manufacturing or maintenance of aircraft 900 in FIG. 9.

In the different illustrative examples, human operators 1016 may operate or interact with at least one of manufacturing equipment 1006, maintenance equipment 1012, or control system 1014. This interaction may be performed to manufacture aircraft 900.

Of course, product management system 1000 may be configured to manage other products other than aircraft 900. Although product management system 1000 has been described with respect to manufacturing in the aerospace industry, product management system 1000 may be configured to manage products for other industries. For example, product management system 1000 may be configured to manufacture products for the automotive industry, as well as any other suitable industries.

Thus, the different illustrative examples provide a method and apparatus for managing three-dimensional massive model visualization data sets. In one illustrative example, three-dimensional massive model visualization data sets may be automatically created and distributed for use by client devices. The automatic creation may allow for three-dimensional massive model visualization data sets to be created prior to those three-dimensional massive model visualization data sets being needed for use. Additionally, with the automated creation, times may be selected when lower use of processor resources occur to increase processor resources available for creating the three-dimensional massive model visualization data sets.

Additionally, the data set manager provides an ability to keep the three-dimensional massive model visualization data sets fresh. In other words, an identification of out-of-date three-dimensional massive model visualization data sets occurs and updated three-dimensional massive model visualization data sets may be created. Further, a client device also may update a three-dimensional massive model visualization data set fresh through different updating mechanisms when the client device determines that the three-dimensional massive model visualization data set is no longer up-to-date. One or more illustrative examples provide a method and apparatus that increases the ease at which users may access and use three-dimensional massive model visualization data sets and client devices.

As depicted, three-dimensional massive model visualization data sets are pre-built in the computer system for use by users on client devices. The users at the client devices may download the three-dimensional massive model visualization data sets without needing to process data to create those data sets.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for managing three-dimensional massive model visualization data sets, the method comprising:
compiling a list of objects for which the three-dimensional massive model visualization data sets are to be built;
automatically building the three-dimensional massive model visualization data sets for the objects in the list using a computer system;
storing the three-dimensional massive model visualization data sets in a group of repositories;
distributing the three-dimensional massive model visualization data sets for displaying massive model visualizations for the objects using the three-dimensional massive model visualization data sets on client devices; and
receiving user input of a request for selectively updating a three-dimensional massive model visualization data set in the three-dimensional massive model visualization data sets when the three-dimensional massive model visualization data set is out-of-date.

2. The method of claim 1, wherein selectively updating the three-dimensional massive model visualization data set in the three-dimensional massive model visualization data sets when the three-dimensional massive model visualization data set is out-of-date comprises:
updating the three-dimensional massive model visualization data set located on the group of repositories.

3. The method of claim 1 further comprising:
selectively updating the three-dimensional massive model visualization data set in the three-dimensional massive model visualization data sets when the three-dimensional massive model visualization data set is out-of-date when the user input is received through updating the three-dimensional massive model visualization data set located on a client device by downloading information to rebuild the three-dimensional massive model visualization data set.

4. The method of claim 3 further comprising:
updating the three-dimensional massive model visualization data set located on the client device when the user input is received by downloading all of a newest three-dimensional massive model data set from a repository.

5. The method of claim 3 further comprising:
updating the three-dimensional massive model visualization data set located on the client device when the user input is received by rebuilding a first portion of the three-dimensional massive model visualization data set on the client device that is out-of-date while a second portion of the three-dimensional massive model visualization data set is unchanged.

6. The method of claim 1 further comprising:
selectively updating the three-dimensional massive model visualization data set in the three-dimensional massive model visualization data sets when the three-dimensional massive model visualization data set is out-of-date when the user input is received by updating the three-dimensional massive model visualization data set on a client device by at least one of masking a first group of models or adding a second group of models.

7. The method of claim 3 further comprising:
updating the three-dimensional massive model visualization data set located on the client device when the user input is received by rebuilding of all of the three-dimensional massive model visualization data set on the client device that is out-of-date.

8. The method of claim 1 further comprising:
displaying the massive model visualizations for the objects on the client devices using the three-dimensional massive model visualization data sets.

9. The method of claim 1 further comprising:
displaying a massive model visualization for a given object from the list of objects that are displayable using the three-dimensional massive model visualization data sets stored in the group of repositories in the computer system, to thereby display a given configuration of an object from the list of objects.

10. The method of claim 1, wherein the three-dimensional massive model visualization data set in the three-dimensional massive model visualization data sets represents an instance of an object.

11. The method of claim 1, wherein the objects are selected from at least one of a mobile platform, a stationary platform, a land-based structure, an aquatic-based structure, a space-based structure, an aircraft, a surface ship, a tank, a personnel carrier, a train, a spacecraft, a space station, a satellite, a submarine, an automobile, a power plant, a bridge, a dam, a house, a manufacturing facility, and a building.

12. A method of displaying three-dimensional massive model visualization data sets on a client device, the method comprising:
displaying a vehicle list of vehicles displayable that are on the client device;
downloading a three-dimensional massive model visualization data set in the three-dimensional massive model visualization data sets corresponding to a vehicle selected from the vehicle list from a group of repositories in a computer system; and
displaying a massive model visualization of the vehicle using the three-dimensional massive model visualization data set downloaded to the client device.

13. The method of claim 12 further comprising:
selectively updating the three-dimensional massive model visualization data set prior to displaying the massive model visualization of the vehicle using the three-dimensional massive model visualization data set downloaded to the client device when the three-dimensional massive model visualization data set is out-of-date and when a user input is received to update the three-dimensional massive model visualization data set.

14. The method of claim 13 further comprising:
comparing time stamps between the three-dimensional massive model visualization data set located on the client device with a source copy of the three-dimensional massive model visualization data set on a repository.

15. The method of claim 13, wherein selectively updating the three-dimensional massive model visualization data set when the three-dimensional massive model visualization data set is out-of-date and when the user input is received to update the three-dimensional massive model visualization data set comprises:
updating the three-dimensional massive model visualization data set located on the group of repositories in the computer system when the user input is received to update the three-dimensional massive model visualization data set.

16. The method of claim 13, wherein selectively updating the three-dimensional massive model visualization data set when the three-dimensional massive model visualization data set is out-of-date and when the user input is received to update the three-dimensional massive model visualization data set comprises:
updating the three-dimensional massive model visualization data set located on the client device when the user input is received to update the three-dimensional massive model visualization data set.

17. The method of claim 16, wherein updating the three-dimensional massive model visualization data set located on the client device when the user input is received to update the three-dimensional massive model visualization data set comprises:
downloading all of a newest three-dimensional massive model visualization data set from a repository when the user input is received to update the three-dimensional massive model visualization data set.

18. The method of claim 16, wherein updating the three-dimensional massive model visualization data set located on the client device when the user input is received to update the three-dimensional massive model visualization data set comprises:
rebuilding a first portion of the three-dimensional massive model visualization data set on the client device that is out-of-date while a second portion of the three-dimensional massive model visualization data set is unchanged when the user input is received to update the three-dimensional massive model visualization data set.

19. The method of claim 13, wherein selectively updating the three-dimensional massive model visualization data set when the three-dimensional massive model visualization data set is out-of-date and when the user input is received to update the three-dimensional massive model visualization data set comprises:
updating the three-dimensional massive model visualization data set on the client device by at least one of masking a first group of models or adding a second group of models when the user input is received to update the three-dimensional massive model visualization data set.

20. The method of claim 12, wherein the three-dimensional massive model visualization data set in the three-dimensional massive model visualization data sets represents an instance of a vehicle.

21. A three-dimensional massive model visualization data sets system comprising:
a computer system; and
a data set manager in the computer system, wherein the data set manager is configured to compile a vehicle list of vehicles for which three-dimensional massive model visualization data sets are to be built; automatically build the three-dimensional massive model visualization data sets for vehicles in the vehicle list using the computer system; store the three-dimensional massive model visualization data sets in a group of repositories; distribute the three-dimensional massive model visualization data sets for displaying massive model visualizations for the vehicles using the three-dimensional massive model visualization data sets on client devices; and receive user input of a request for selectively updating a three-dimensional massive model visualization data set in the three-dimensional massive model visualization data sets when the three-dimensional massive model visualization data set is out-of-date.

22. The three-dimensional massive model visualization data sets system of claim 21 further comprising:
a client device local to a user that requests a three-dimensional massive model visualization data set in the three-dimensional massive model visualization data sets from the group of repositories for displaying a three-dimensional massive model visualization for the vehicles.

23. The three-dimensional massive model visualization data sets system of claim 21, wherein, the data set manager is configured to update the three-dimensional massive model visualization data set located on model the group of repositories when the three-dimensional massive model visualization data set is out-of-date.

24. The three-dimensional massive model visualization data sets system of claim 22, wherein the client device is configured to selectively update the three-dimensional massive model visualization data set in the three-dimensional massive model visualization data sets when the three-dimensional massive model visualization data set is out-of-date when the user input is received through updating the three-dimensional massive model visualization data set located on the client device by downloading information to rebuild the three-dimensional massive model visualization data set.

25. The three-dimensional massive model visualization data sets system of claim 24, wherein the client device is configured to rebuild all of the three-dimensional massive model visualization data set on the client device when the user input is received.

26. The three-dimensional massive model visualization data sets system of claim 24, wherein the client device is configured to rebuild a first portion of the three-dimensional massive model visualization data set on the client device that is out-of-date while a second portion of the three-dimensional massive model visualization data set is unchanged on the client device when the user input is received.

27. The three-dimensional massive model visualization data sets system of claim 22, wherein the client device is configured to update the three-dimensional massive model visualization data set on a client device by at least one of masking a first group of models or adding a second group of models when the user input is received.

28. The three-dimensional massive model visualization data sets system of claim 24, wherein the three-dimensional massive model visualization data set in the three-dimensional massive model visualization data sets represents an instance of a vehicle.
